(19) United States
(12) Patent Application Publication
(10) Pub. No.: US 2026/0212752 A1
(43) Pub. Date: Jul. 23, 2026

(54) COMPUTERIZED SYSTEMS AND METHODS FOR LOCATION AND USAGE SPECIFIC SENSOR CONFIGURATION AND IMPLEMENTATION

(71) Applicant: RESIDEO LLC, Golden Valley, MN (US)

(72) Inventors: Pat Tessier, Chapel Hill, NC (US); Steven Carlevato, Bolingbrook, IL (US)

(73) Assignee: RESIDEO LLC, Golden Valley, MN (US)

(21) Appl. No.: 19/141,526

(22) PCT Filed: Dec. 21, 2023
(86) PCT No.: PCT/US2023/085326

§ 371 Date: Jun. 20, 2025

Related U.S. Application Data
(60) Provisional application No. 63/476,457, filed on Dec. 21, 2022.

(51) Int. Cl. G08B 29/18

(52) U.S. Cl. CPC G08B 29/18

(57) ABSTRACT

Disclosed are systems and methods that provide novel functionality for the configuration of a novel type of security and/or safety detector (or sensor) The disclosed framework provides functionally that enables the configuration of a detector that accounts for determined parameters, attributes and/or characteristics related to, but not limited to, how the detector is intended to be used, how it is actually being used (e.g., real-time data and/or collected and determined behavior data of the sensor, and/or data related to the location (e.g., building) and/or occupants it is being used to protect), its positioning within the location, and the like or some combination thereof. The disclosed framework enables a dynamic sensor configuration that can adapt to its positioning, how it was initially configured and/or the real-time environment surrounding its operation, which improves how occupants of a location and/or the location is protected.

### CROSS-REFERENCE TO RELATED APPLICATION

This application claims the benefit of, and priority to, U.S. Provisional Patent Application No. 63/476,457, filed Dec. 21, 2022, its entirety of which is incorporated herein by reference.

### FIELD OF THE DISCLOSURE

The present disclosure is generally related to a security monitoring system, and more particularly, to a decision intelligence (DI)-based computerized framework for deterministically configuring a security and/or safety sensor(s) for a location based on the sensor's intended and/or actual use, as well as the sensor's location.

### BACKGROUND

Current building codes require smoke and carbon monoxide (CO) detectors to be located strategically throughout a building (e.g., a home or office, for example). While this is implemented to protect its occupants, there are drawbacks that impact how well such occupants are protected. That is, conventional detectors are uniformly configured (e.g., as a commercial-off-the-shelf (COTS) detector/sensor), and using them in different locations of a home may limit their effectiveness. For example, a smoke alarm situated near the kitchen may trigger many false alarms due to ordinary smoke from cooking, whereas a smoke alarm near the bathroom may be effected by mist, moisture or other forms of water droplets (e.g., condensation), thereby impacting its functionality.

### SUMMARY OF THE DISCLOSURE

As such, conventional detectors or sensors configured at and/or around a building (e.g., home, office, garage, or other type of confined structure) are limited in how they can be implemented, and further may encounter or be positioned in an environment that limits, restricts and/or prevents their intended use. For example, if a smoke detector is positioned in a living room of a home that has a wood burning fireplace, the detector may encounter a large amount of dust from the ash of the burning fire, thereby preventing it from operating correctly (if at all). In another non-limiting example, if a CO detector is in a garage, accumulated dust in the area may also prevent the detector from operating effectively and properly.

Thus, the disclosed systems and methods provide a novel type of security and/or safety detector (or sensor, used interchangeably) that can be configured based on its intended and/or actual use, as well as the specific positioning within the location. Accordingly, disclosed is a computerized framework that enables the novel configuration of a detector, that accounts for parameters, attributes and/or characteristics related to, but not limited to, how the detector is intended to be used, how it is actually being used (e.g., real-time data and/or collected and determined behavior data of the sensor, and/or data related to the location (e.g., building) and/or occupants it is being used to protect), its positioning within the location, and the like or some combination thereof.

Therefore, according to some embodiments, the disclosed framework enables a dynamic sensor configuration that can adapt to its positioning, how it was initially configured and/or the real-time environment surrounding its operation, which improves how occupants of a location and/or the location are protected. In some embodiments, the disclosed framework can dynamically adjust its operation and/or sensor collection mechanisms based on real-time detected events, thereby enabling an adaptable detector to oversee the activities of a location while accounting for specific factors impacting and/or occurring at that location.

According to some embodiments, a method is disclosed for deterministically configuring a security and/or safety sensor(s) for a location based on the sensor's intended and/or actual use, as well as the sensor's location. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for deterministically configuring a security and/or safety sensor(s) for a location based on the sensor's intended and/or actual use, as well as the sensor's location.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary work flow according to some embodiments of the present disclosure;

FIG. 4 illustrates an exemplary workflow according to some embodiments of the present disclosure;

FIG. 5 depicts an exemplary implementation of an architecture according to some embodiments of the present disclosure;

FIG. 6 depicts an exemplary implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, the disclosed systems and methods provide advanced mechanisms for security and/or safety detectors (e.g., smoke alarms, CO alarms, and the like) to be specifically and dynamically tailored to the practical, real-world environment for which it is to operate and/or is operating. In addition to the improved safety this would provide, such configurable security can streamline how customers purchase and/or implement security systems, as a one-size fits all system can be adapted for each type of operating environment.

It should be understood that while the discussion herein may focus on smoke and/or CO detectors, it should not be construed as limiting, as any type of known or to be known sensor and/or detector capable of being utilized within a security system and/or by a security system to monitor activity in and/or around a location can be utilized herein without departing from the scope of the instant disclosure.

According to some embodiments, as discussed herein, the disclosed systems and methods provide novel functionality that enables the specific configuration of a detector to match its operational environment, and modify its operational modes accordingly. In some embodiments, the disclosed framework can enable the configuration of a detector prior to its commissioning and/or during its implementation, whereby the detector can monitor a location for events (e.g., specific types of activity and/or types of no-activity) based on provided information related to the location and/or real-time detected information at/around the location, as discussed herein.

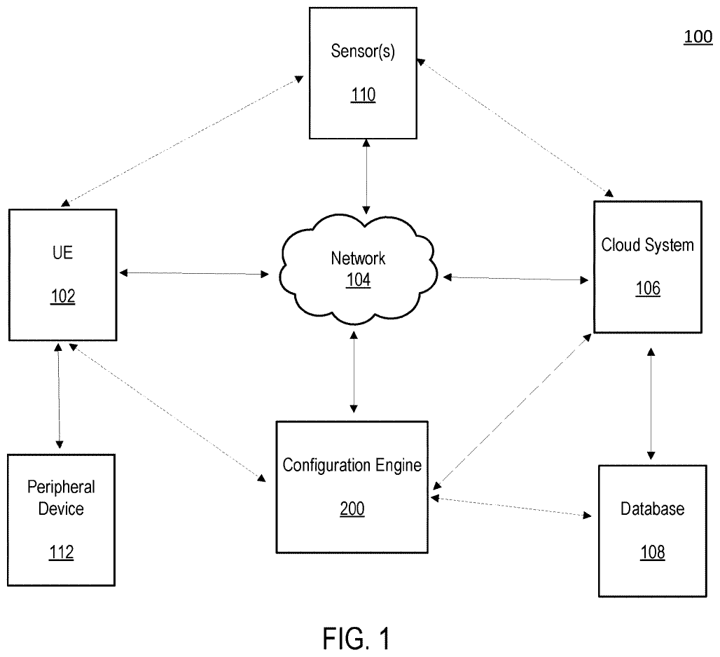

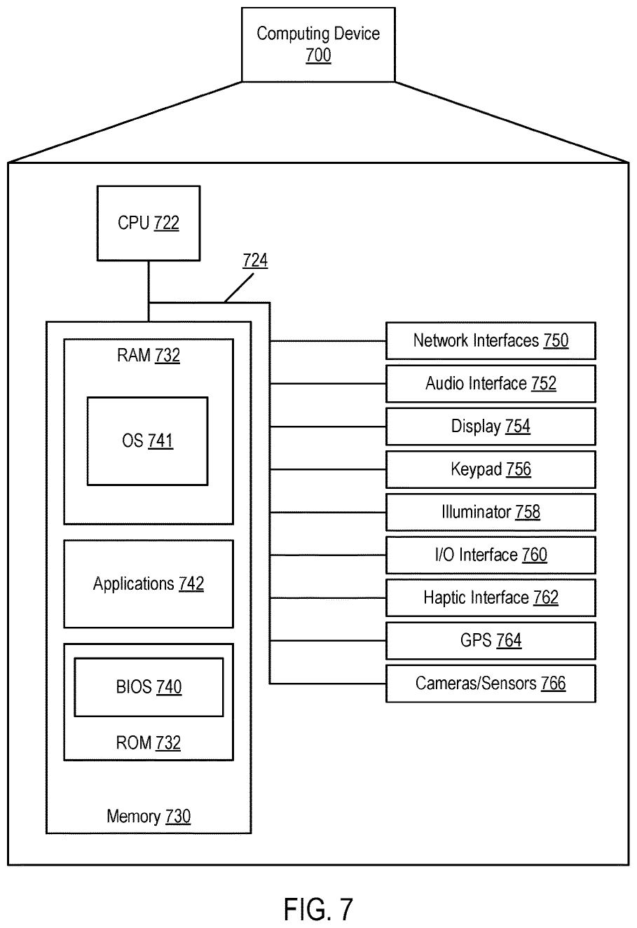

With reference to FIG. 1, system 100 is depicted which includes UE 102 (e.g., a client device, as mentioned above and discussed below in relation to FIG. 7), sensors 110, network 104, cloud system 106, database 108, configuration engine 200 and peripheral device 112. It should be understood that while system 100 is depicted as including such components, it should not be construed as limiting, as one of ordinary skill in the art would readily understand that varying numbers of UEs, peripheral devices, sensors, cloud systems, databases and networks can be utilized; however, for purposes of explanation, system 100 is discussed in relation to the example embodiment depicted in FIG. 1.

According to some embodiments, UE 102 can be any type of device, such as, but not limited to, a mobile phone, tablet, laptop, sensor, Internet of Things (IOT) device, autonomous machine, and any other device equipped with a cellular or wireless or wired transceiver. In some embodiments, UE 102 can be a device associated with an individual (or set of individuals) for which security services are being provided. In some embodiments, UE 102 may correspond to a device of a security entity (e.g., a security provider, whereby the device is a security panel and has corresponding sensors 110, as discussed herein).

In some embodiments, peripheral device 112 can be connected to UE 102, and can be any type of peripheral device, such as, but not limited to, a wearable device (e.g., smart watch), printer, speaker, sensor, and the like. In some embodiments, peripheral device 112 can be any type of device that is connectable to UE 102 via any type of known or to be known pairing mechanism, including, but not limited to, Bluetooth™, Bluetooth Low Energy (BLE), NFC, and the like.

According to some embodiments, sensors 110 can correspond to a sensor(s) associated with a location of system 100. In some embodiments, the sensors 110 can be associated with security sensors, such as, for example, smoke and/or CO alarms, as discussed above. In some embodiments, sensors 110 can also and/or alternatively include, but are not limited to, cameras, glass break detectors, motion detectors, door and window contacts, heat and smoke detectors, passive infrared (PIR) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®), Nest®, for example)), smart phones, smart watches or other wearables, tablets, personal computers, and the like, and some combination thereof. For example, the sensors 110 can include the sensors on UE 102 (e.g., smart phone) and/or peripheral device 112 (e.g., a paired smart watch).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a security system provider, which has associated network resources hosted on the internet or private network (e.g., network 104), which enables (via engine 200) the security configuration and management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of UE 102/device 112 and the UE 102/device 112, sensors 110, and the services and applications provided by cloud system 106 and/or configuration engine 200.

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

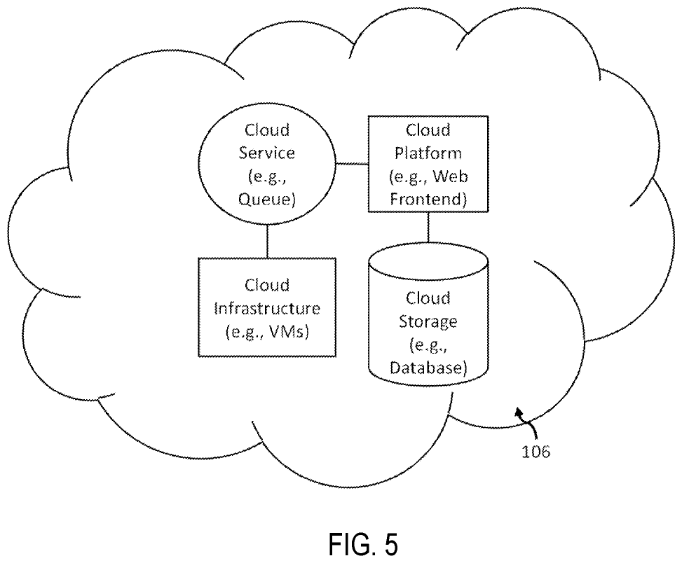

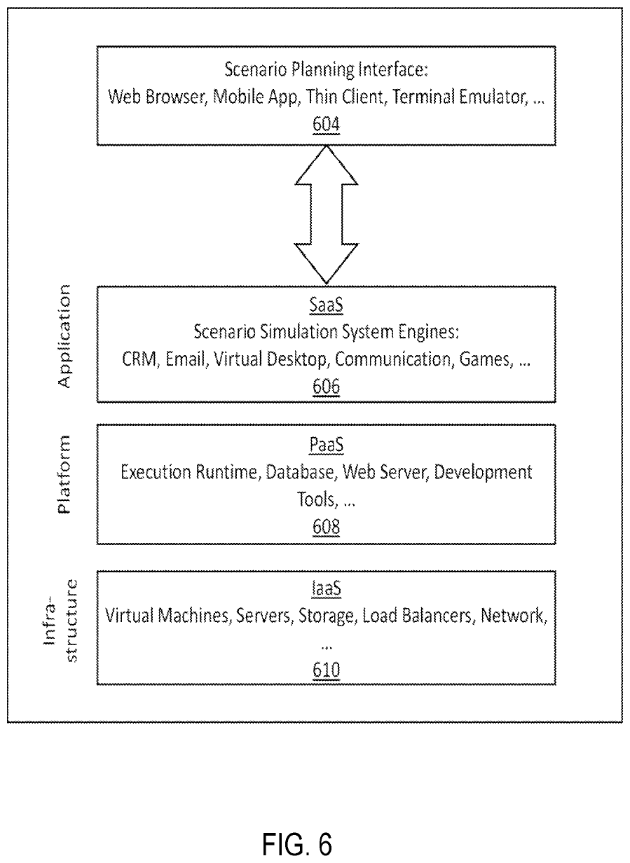

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure a service (IaaS) 610, platform as a service (PaaS) 608, and/or software as a service (Saas) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted APIs of the present disclosure may be specifically configured to operate.

Turning back to FIG. 1, according to some embodiments, database 108 may correspond to a data storage for a platform (e.g., a network hosted platform, such as cloud system 106, as discussed supra), a plurality of platforms, and/or UE 102 and/or sensors 110. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Configuration engine 200, as discussed above and further below in more detail, can include components for the disclosed functionality. According to some embodiments, configuration engine 200 may be a special purpose machine or processor, and can be hosted by a device on network 104, within cloud system 106, on UE 102 (and/or peripheral device 112) and/or within sensors 110. In some embodiments, engine 200 may be hosted by a server and/or set of servers associated with cloud system 106.

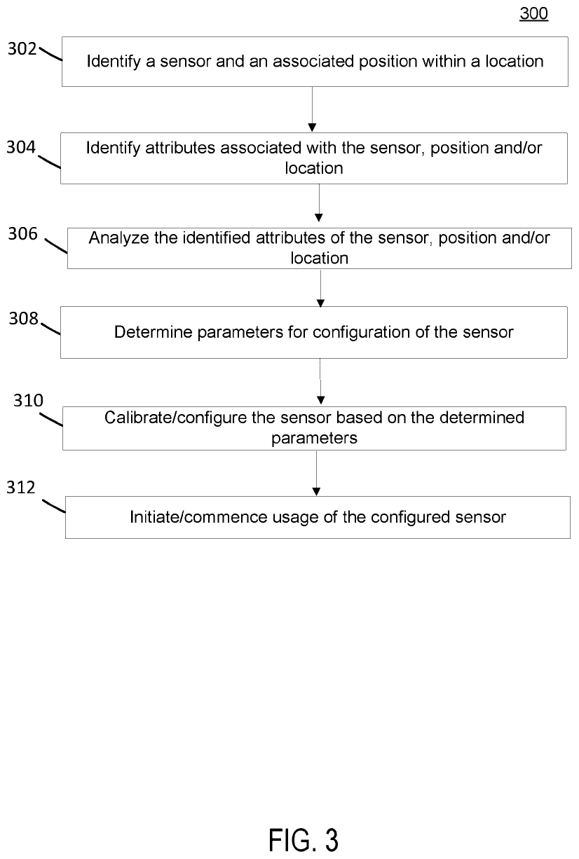

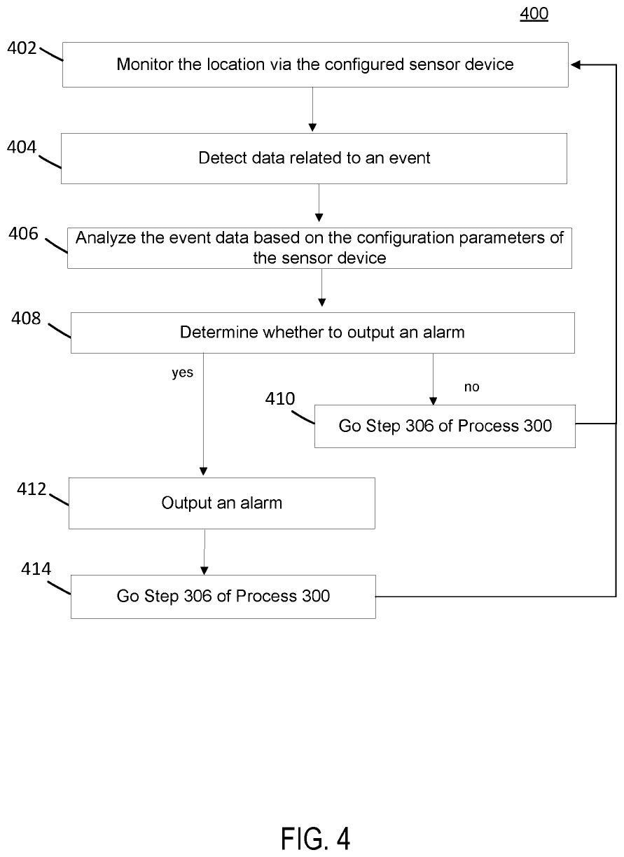

According to some embodiments, as discussed in more detail below, configuration engine 200 may be configured to implement and/or control a plurality of services and/or microservices, where each of the plurality of services/microservices are configured to execute a plurality of workflows associated with performing the disclosed sensor configuration and implementation thereof. Non-limiting embodiments of such workflows are provided below in relation to at least FIGS. 3-4.

According to some embodiments, as discussed above, configuration engine 200 may function as an application provided by cloud system 106. In some embodiments, engine 200 may function as an application installed on a server(s), network location and/or other type of network resource associated with system 106. In some embodiments, engine 200 may function as application installed and/or executing on UE 102. In some embodiments, such application may be a web-based application accessed by UE 102 and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on UE 102 and/or sensors 110.

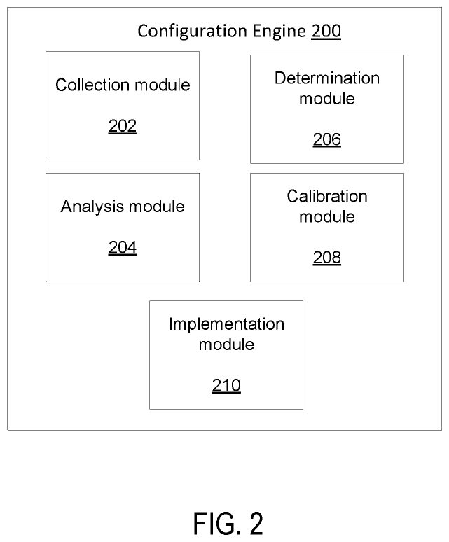

As illustrated in FIG. 2, according to some embodiments, configuration engine 200 includes collection module 202, analysis module 204, determination module 206, calibration module 208 and implementation module 210. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed configuration of a sensor for a specific location and/or use, as discussed herein.

According to some embodiments, as discussed herein, Process 300 provides capabilities for performing the calibration/configuration of a sensor at a location (e.g., building, for example). Accordingly, in some embodiments, as discussed herein, Process 300 can enable the specific tailoring of the detector/sensor device based on, but not limited to, the detector's intended use, where the detector is located and/or and any special circumstances related to the location (e.g., for example, in a hotel room with ample sources of dust, in a garage with excess dust and insects, in a hallway outside a bathroom with a shower, in a kitchen that experience abnormal smoke conditions, and the like, or some combination thereof). Implementation and dynamic updating of such configuration is discussed in relation to Process 400 of FIG. 4, infra.

According to some embodiments, Steps 302-304 of Process 300 can be performed by collection module 202 of configuration engine 200; Step 306 can be performed by analysis module 204; Step 308 can be performed by determination module 206; Step 310 can be performed by calibration module 208; and Step 312 can be performed by implementation module 210.

According to some embodiments, Process 300 begins with Step 302 where engine 200 can identify a sensor (or sensor device, or detector, used interchangeably) and an associated position within a location (e.g., building). According to some embodiments, the identified sensor can be installed within a position at the location (e.g., on the ceiling over a doorway in a living room of a home, for example). Non-limiting examples of sensors and the types of collectable data are discussed above at least in relation to FIG. 1.

For purposes of disclosure, a single sensor will be referenced for the discussion related to Process 300 (and Process 400); however, it should not be construed as limiting, as one of ordinary skill in the art would understand that any number of sensors, inclusive any a variety of types of such sensors, can be utilized as part of the steps of Process 300 (and Process 400, discussed infra) without departing from the scope of the instant disclosure.

In some embodiments, Step 302 can involve the identified sensor being connected to engine 200. According to some embodiments, engine 200 can operate as a centralized “security panel” for the location. In some embodiments, with reference to FIG. 1, for example, sensors 110 can be paired with each other, with engine 200 and/or UE 102, which can be paired via connectivity protocols provided and/or enabled via engine 200. For example, a security sensor 110 can be paired/connected with another sensor 110, engine 200 and/or UE 102 via BLE technology. In some embodiments, the sensors 110 can be paired and/or connected with another sensor 110, engine 200 and/or UE 102 via a physical wire connection (e.g., fiber, ethernet, coaxial, and/or any other type of known or to be known wiring to hardwire a home for network connectivity for devices operating therein). In some embodiments, the sensors 110 can be paired/connected with another sensor 110, engine 200 and/or UE 102 via a cloud-to-cloud (C2C) connection (e.g., establish connection with a third party cloud, which connects with cloud system 106, for example). In some embodiments, the sensors 110 can be paired/connected via a combination of network capabilities, hard wiring and/or C2C. In some embodiments, the sensors 110 can be paired so as enable an extended reach of the sensor's configuration to detect specific types of events.

In Step 304, engine 200 can identify attributes associated with the sensor, position and/or the location. According to some embodiments, the attributes can correspond to, but are not limited to, a quantity of sensors for a location, a type of each sensor, a type of location, identity of the location, identity and/or quantity of users at the location (e.g., who lives/works at the location, for example), behavioral patterns of the users at the location, proximity within the location to another sensor, a type of security system, climate in and/or around the location, type of activity at/around the location and/or position, fixtures at the location/position, and the like, or some combination thereof.

Thus, overall, according to some embodiments, the attributes can provide information related to the sensor's intended use, as well as the environment within which it will operate (the surrounding area of the position within the location).

In some embodiments, Step 304 can involve engine 200 broadcasting a ping message to the sensors (e.g., via UE 102, for example), whereby information related to the sensor and/or position/location can be collected and analyzed, for which the attribute information can be determined; in some embodiments, the attribute information can be provided by a user(s); and in some embodiments, the information can be provided by some combination thereof.

In Step 306, engine 200 can analyze the identified attributes (from Step 304), and in Step 38, determine parameters for the configuration of the sensor.

According to some embodiments, engine 200 can implement any type of known or to be known computational analysis technique, algorithm, mechanism or technology to analyze the attribute information (from Step 304) in order to perform the determination of Step 308.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques including, but not limited to, computer vision, feature vector analysis, decision trees, boosting, support-vector machines, neural networks, nearest neighbor algorithms, Naive Bayes, bagging, random forests, logistic regression, and the like. For example, engine 200 can implement an XGBoost algorithm for classification of data for which a sensor can utilize to enable its operation, as discussed herein.

In some embodiments and, optionally, in combination of any embodiment described above or below, a neutral network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In some embodiments, the analysis and determination in Steps 306-308 can be performed at least partially via input, which can be provided by an application, user and/or another device (e.g., a device operating at the location and/or a networked device associated with cloud network, for example).

According to some embodiments, the determination performed by engine 200 can involve correlating, equating and/or deriving the parameters from/to the attributes. That is, for example, if the area in the location for which the sensor is to be positioned is subject to large (or abnormal) quantities of dust (e.g., dust particle above a threshold value, for example), then engine 200 can determine parameters for the sensor to operate (e.g., an mode of operation) that can filter out specific detected values of dust.

In another non-limiting example, if the sensor is a smoke detector, and is located in the kitchen, the sensor can be determined to be subject to a particular level/amount of smoke. For example, this smoke amount would normally trigger the smoke alarm to output an alarm (e.g., via the COTS settings of the smoke alarm). However, via the analysis and determination in Steps 306-308, engine 200 can determine parameters that enable the smoke detector to filter out a certain amount of smoke (beyond the COTS levels), while still maintaining the smoke detection presence in the position/location to protect the occupants of the kitchen/home. In some embodiments, such parameters can be determined via the AI/ML processing discussed above.

Thus, according to some embodiments, engine 200 can determine information that can be leveraged into parameters for configuration of the sensor which can include, but are not limited to, values/amounts of event data that default for the type of sensor (e.g., amount of smoke that will trigger the smoke alarm, for example), values/amounts that typically occur at/around the position/location, a deviation to account for between the COTS values and the determined values, a time period to dismiss/filter the deviation, a weight to the type of event data (e.g., CO₂ being more dangerous than smoke given smoke is visible, for example), and the like, or some combination thereof.

In Step 310, engine 200 can calibrate/configure the sensor based on the determined parameters (or determined configuration parameters, used interchangeably, as per Step 308). According to some embodiments, engine 200 can compile the determined parameters into machine readable, machine-executable instructions (e.g., an executable data structure or program logic, for example), which can be provided to the sensor for execution. Thus, the sensor can be configured via execution of the provided instructions which can modify its operation and/or operational modes based on the determined parameters. According to some embodiments, such configuration can involve the modification of an initial (or original or prior) configuration to a modified configuration that alters the functionality and/or capability of the sensor, as discussed herein. Accordingly, in some embodiments, the calibration/configuration can involve loading the instructions into a memory associated with the sensor.

In some embodiments, as mentioned above, information related to the determined parameters, compiled instructions, as well as the attributes of the sensor, position and/or location, can be stored in database 108. In some embodiments, the compiled instructions can be configured with a header that corresponds to an operational mode. Thus, a sensor can be dynamically configured based on detected events, time of day, date, user activity, and the like, which can involve the automatic switching of modes as provided via the determined parameters discussed herein.

By way of a non-limiting example, a smoke detector positioned in the kitchen of a home is configured to ignore/filter out a certain amount of smoke, and such filtering corresponds to an operational mode for “diner time”. However, when the occupants of the home are not cooking (e.g., not at night, for example), engine 200 can provide alternative instructions to the smoke detector which cause it to be more sensitive to smoke given its proximity to gas and other types of volatile appliances (e.g., stove, for example). For example, when a time proximate to diner time occurs (or it is detected that a user has entered the kitchen and/or has turned on the stove for example), engine 200 can trigger instructions to be sent and loaded/executed by the smoke detector that again filter out the smoke.

Therefore, for example, engine 200 can dynamically retrieve corresponding instructions from database 108 based on a criteria (e.g., time, usage, and the like, for example, as discussed above), and automatically provide them to the sensor for monitoring of the location/position based on real-time factors. In some embodiments, as discussed below, each set of instructions (or parameters, and a corresponding data structure) can be modified based on further detected events, as discussed below in relation to Process 400 of FIG. 4.

In Step 312, engine 200 can initiate/commence operation/usage of the automatically and dynamically configured sensor. Such operation is discussed in more detail below.

Turning to FIG. 4, Process 400 provides non-limiting example embodiments for the deployment and/or implementation of the configured detector/sensor device (from Process 300, discussed supra). According to some embodiments, Steps 402-414 of Process 400 can be performed by implementation module 206 of configuration engine 200.

According to some embodiments, Process 400 begins with Step 402 where engine 200, via the configured sensor, monitors the location. As discussed above, the location can correspond to a predefined physical/geographic location (e.g., a house or building).

In some embodiments, engine 200 can monitor the location continuously, and/or according to a predetermined time interval. In some embodiments, the monitoring can involve periodically pinging each or a portion of the sensors at the location, and awaiting a reply. In some embodiments, the monitoring can involve push and/or fetch protocols to collect sensor data from each sensor.

In Step 404, based on the monitoring of the location, engine 200 can detect an event. In some embodiments, the detection of the event can involve a sensor or sensors at the location detecting sensor data for an event, which in some embodiments, can be electronically collected and/or communicated via engine 200, as discussed above. In some embodiments, the sensor data can correspond to measurements of particular type of data (e.g., measured amount of smoke, CO₂, noise/sound, activity, and the like, for example).

In some embodiments, an event can correspond to activity at the location (e.g., certain measurements, amounts and/or levels of smoke, CO₂, and/or any other type of detectable chemical/element, a user moving, an item moving, a pet moving, and the like, or some combination thereof). In some embodiments, the activity may have to be performed according to a criteria including, but not limited to, be a particular amount, volume, metric, value and/or size, and can be based on a predetermined period of time (e.g., 10 seconds), date position within a location (e.g., a sub-location), and the like, or some combination thereof.

In some embodiments, the event can also, or alternatively, correspond to non-activity, which can correspond to a criteria related to, but not limited to, lack of detected chemicals/elements, movement of a user, item or other identifiable object for a predetermined period of time, a time, a date, position within the location (e.g., a sub-location), and the like, or some combination thereof. For example, a sensor is not only not detecting smoke input for a predetermined period of time (e.g., 30 seconds), but also not detecting any other type of elemental input, which may indicate the sensor is not operating correctly.

In Step 406, engine 200 can analyze the detected event information based on the configuration parameters of the sensor device, and determine if the type of data and/or measurement values of the data correspond to types and/or measurements for which the sensor is configured to detect and/or alert occupants to. In some embodiments, such analysis can be performed in a similar manner as discussed above at least in relation to Step 306 of Process 300 of FIG. 3. According to some embodiments, engine 200 can implement any known or to be known analysis algorithm, technique or mechanism to perform such the analysis and determination (of Steps 406-408, respectively), including, but not limited to, feature vector analysis, decision trees, boosting, support-vector machines, neural networks, nearest neighbor algorithms, Naive Bayes, bagging, random forests, logistic regression, and the like.

For example, an event can be translated to an n-dimensional feature vector, whereby a comparison between nodes of the feature vector of the event may be compared to nodes of feature vectors of the determined parameters for the sensor. Should the similarity values be at or above a threshold, then a similar event may have been detected.

Accordingly, engine 200 can perform the analysis (and subsequent determination discussed below in relation to Step 408) in a similar manner as discussed above at least in relation to Steps 306 and 308 of Process 300 of FIG. 3, discussed supra.

In Step 408, based on the analysis from Step 406, engine 200 can determine an event the sensor device is configured to detect has occurred, and if so, should an alarm be output.

In some embodiments, when the event is determined to correlate to an event for which the sensor is configured to detect (e.g. smoke is detected at heightened levels in the kitchen, for example, as discussed above), Process 400 can proceed to Step 412.

In Step 412, engine 200 can cause the security system (e.g., which can be effectuated via sensor 110 and/or UE 102, for example) to output an alarm. In some embodiments, Step 412 can further involve the event data being stored, as discussed above. In some embodiments, the event data can be further utilized to train engine 200 to determine corresponding events for future events.

In Step 416, engine 200 can then proceed to Step 306 of Process 300, whereby attributes of the event can be further analyzed for further configuration (e.g., “fine-tuning”) of the sensor, thereby enabling the sensor and/or its configuration to account for the most up-to-date data available.

Accordingly, engine 200 may then continue monitoring the location. In some embodiments, the monitoring does not stop upon detection of an event, but continues running in the backend (e.g., implementation module 210), while certain modules of engine 200 analyze each detected event.

In some embodiments, when the event is determined to not require an alarm to be output (e.g., not be at least a threshold amount of similarity a determined parameter/setting), Process 400 can proceed from Step 408 to Step 410. In Step 410, engine 200 performs similar activity of Step 414, whereby the sensor can be further calibrated based on the most recent collected sensor data. Accordingly, the configured sensor can continue monitoring the location, as discussed above.

FIG. 7 is a schematic diagram illustrating a client device showing an example embodiment of a client device that may be used within the present disclosure. Client device 700 may include many more or less components than those shown in FIG. 7. However, the components shown are sufficient to disclose an illustrative embodiment for implementing the present disclosure. Client device 700 may represent, for example, UE 102 discussed above at least in relation to FIG. 1.

As shown in the figure, in some embodiments, Client device 700 includes a processing unit (CPU) 722 in communication with a mass memory 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising steps of:
identifying, by a device, information related to a sensor, the sensor being associated with a position at a location;
identifying, by the device, attributes associated with the sensor, the position and the location;
analyzing, by the device, the identified attributes, and determining, based on the analysis, configuration parameters for the sensor, the configuration parameters enabling a modified implementation of the sensor that corresponds to the identified attributes;
configuring, by the device, the sensor based on the determined configuration parameters, the configuration comprising modifying initial configuration parameters of the sensor based on the determined configuration parameters, such that the modified implementation is enabled; and
initiating, by the device, the sensor for operation at the position within the location, the operation corresponding to a security and safety monitoring of the location.

2. The method of claim 1, further comprising:
detecting, based on the monitoring of the location via the configured sensor, data related to an event;
analyzing the event data based on the determined configuration parameters; and
determining, based on the analysis, whether to output an alarm for the event.

3. The method of claim 2, further comprising:
determining, based on the analysis of the event data, that the determined configuration parameters of the configured sensor filter out the event data, wherein the determination to output the alarm comprises determining for the alarm to remain silent.

4. The method of claim 2, further comprising:
determining, based on the analysis of the event data, that the determined configuration parameters of the configured sensor correspond to detection of the event data, wherein the determination to output the alarm comprises determining to output the alarm.

5. The method of claim 2, further comprising:
determining updated configuration parameters for the sensor based on information related to the alarm determination and event data.

6. The method of claim 1, wherein the event data comprises information related to a type of data specific to a type of the sensor.

7. The method of claim 1, wherein the event data comprises measurements of specific types of data, wherein the alarm determination corresponds to whether the determined configuration parameters of the configured sensor involve detecting values associated with the measurements.

8. The method of claim 1, wherein the determined configuration parameters correspond to a specific operational mode of the sensor, wherein the sensor comprises a plurality of operational modes.

9. The method of claim 1, further comprising:
identifying a plurality of sensors, each sensor corresponding to a different position within the location, wherein the steps are performed for each of the plurality of sensors.

10. A device comprising:
at least one processor configured to:
identify information related to a sensor, the sensor being associated with a position at a location;
identify attributes associated with the sensor, the position and the location;
analyze the identified attributes, and determine, based on the analysis, configuration parameters for the sensor, the configuration parameters enabling a modified implementation of the sensor that corresponds to the identified attributes;
configure the sensor based on the determined configuration parameters, the configuration comprising modifying initial configuration parameters of the sensor based on the determined configuration parameters, such that the modified implementation is enabled; and
initiate the sensor for operation at the position within the location, the operation corresponding to a security and safety monitoring of the location.

11. The device of claim 10, wherein the processor is further configured to:
detect, based on the monitoring of the location via the configured sensor, data related to an event;
analyze the event data based on the determined configuration parameters; and
determine, based on the analysis, whether to output an alarm for the event.

12. The device of claim 11, wherein the processor is further configured to:
determine, based on the analysis of the event data, that the determined configuration parameters of the configured sensor filter out the event data, wherein the determination to output the alarm comprises determining for the alarm to remain silent.

13. The device of claim 11, wherein the processor is further configured to:
determine, based on the analysis of the event data, that the determined configuration parameters of the configured sensor correspond to detection of the event data, wherein the determination to output the alarm comprises determining to output the alarm.

14. The device of claim 11, wherein the processor is further configured to:
determine updated configuration parameters for the sensor based on information related to the alarm determination and event data.

15. The device of claim 10, wherein the event data comprises information related to a type of data specific to a type of the sensor, wherein the event data comprises measurements of specific types of data, wherein the alarm determination corresponds to whether the determined configuration parameters of the configured sensor involve detecting values associated with the measurements.

16. A non-transitory computer-readable storage medium tangibly encoded with computer-executable instructions that when executed by a device, perform a method comprising:
identifying, by the device, information related to a sensor, the sensor being associated with a position at a location;
identifying, by the device, attributes associated with the sensor, the position and the location;
analyzing, by the device, the identified attributes, and determining, based on the analysis, configuration parameters for the sensor, the configuration parameters enabling a modified implementation of the sensor that corresponds to the identified attributes;
configuring, by the device, the sensor based on the determined configuration parameters, the configuration comprising modifying initial configuration parameters of the sensor based on the determined configuration parameters, such that the modified implementation is enabled; and
initiating, by the device, the sensor for operation at the position within the location, the operation corresponding to a security and safety monitoring of the location.

17. The non-transitory computer-readable storage medium of claim 16, further comprising:
detecting, based on the monitoring of the location via the configured sensor, data related to an event;
analyzing the event data based on the determined configuration parameters; and
determining, based on the analysis, whether to output an alarm for the event.

18. The non-transitory computer-readable storage medium of claim 17, further comprising:
determining, based on the analysis of the event data, that the determined configuration parameters of the configured sensor filter out the event data, wherein the determination to output the alarm comprises determining for the alarm to remain silent.

19. The non-transitory computer-readable storage medium of claim 17, further comprising:
determining, based on the analysis of the event data, that the determined configuration parameters of the configured sensor correspond to detection of the event data, wherein the determination to output the alarm comprises determining to output the alarm.

20. The non-transitory computer-readable storage medium of claim 17, further comprising:
determining updated configuration parameters for the sensor based on information related to the alarm determination and event data.
